(19) United States
(12) Patent Application Publication
(10) Pub. No.: US 2026/0287747 A1
(43) Pub. Date: Sep. 24, 2026

(54) ELECTRONIC DEVICE

(71) Applicant: Advanced Semiconductor Engineering, Inc., Kaohsiung (TW)

(72) Inventor: Wei-Zhen QIU, Kaohsiung (TW)

(73) Assignee: Advanced Semiconductor Engineering, Inc., Kaohsiung (TW)

(21) Appl. No.: 19/086,082

(22) Filed: Mar. 20, 2025

(51) Int. Cl. G01S 17/10; G01S 7/481; G01S 7/4865

(52) U.S. Cl. CPC G01S 17/10; G01S 7/4813; G01S 7/4865

(57) ABSTRACT

The present disclosure relates to an electronic device. The electronic device includes a first sensing element and a second sensing element. The first sensing element is configured to detect a distance to an object to be grabbed on a first scale. The second sensing element is configured to detect the distance to the object on a second scale. A precision of the second scale is different than that of the first scale.

### BACKGROUND

### 1. Technical Field

The present disclosure generally relates to an electronic device, and more particularly to an electronic device including a robotic arm and a distance sensing element mounted on the robotic arm.

### 2. Description of the Related Art

Currently, the primary sensing systems of artificial intelligent (AI) machines (such as humanoid robots) are typically located in the central system (for example, the head), responsible for calculating the distance of the machine for the activities thereof. However, for more precise operations, driving the entire robot to simulate human's movements is very complex and requires higher power consumption. In addition, when the AI computation is utilized, the robot may require significant power consumption during the execution of actions. Therefore, an improved electronic device with sensors is called for.

### SUMMARY

In some embodiments, an electronic device includes a first sensing element and a second sensing element. The first sensing element is configured to detect a distance to an object to be grabbed on a first scale. The second sensing element is configured to detect the distance to the object on a second scale. A precision of the second scale is different than that of the first scale.

In some embodiments, an electronic device includes a robot body and a first sensing element. The first sensing element is configured to detect a distance between an object to be grabbed and the robot body. A first part of the robot body is configured to linearly move toward the object without moving a second part of the robot body when the distance is less than a threshold, wherein the first part is different from the second part.

In some embodiments, an electronic device includes a robotic part and a first sensing element. The robotic part includes a retractable element, wherein the retractable element is configured to elongate and/or rotate the robotic part. The first sensing element is configured to detect a first distance between the robotic arm and an object to be grabbed. The robotic part is configured to change a length of the robotic part to capture the object based on data detected by the first sensing element associated with the first distance.

### BRIEF DESCRIPTION OF THE DRAWINGS

Aspects of the present disclosure are readily understood from the following detailed description when read with the accompanying figures. It should be noted that various features may not be drawn to scale. The dimensions of the various features may be arbitrarily increased or reduced for clarity of discussion.

FIG. 1A, FIG. 1B, and FIG. 1C illustrate one or more operations of a method for performing a robotic action, in accordance with some embodiments of the present disclosure.

FIG. 1D is an enlarged perspective view of FIG. 1C, in accordance with different embodiments of the present disclosure.

FIG. 2A is a cross-section of an electronic device, in accordance with some embodiments of the present disclosure.

FIG. 2B is a cross-section of an electronic device, in accordance with some embodiments of the present disclosure.

FIG. 3A is a schematic diagram of an electronic device, in accordance with some embodiments of the present disclosure.

FIG. 3B is a schematic diagram of an electronic device, in accordance with some embodiments of the present disclosure.

FIG. 4A is a schematic diagram of a robotic arm, in accordance with some embodiments of the present disclosure.

FIG. 4B is a schematic diagram of a robotic arm, in accordance with some embodiments of the present disclosure.

FIG. 5 is an enlarged perspective view of a region “5” in FIG. 4A, in accordance with different embodiments of the present disclosure.

FIG. 6A is an enlarged perspective view of a region “6A” in FIG. 4B, in accordance with some embodiments of the present disclosure.

FIG. 6B is a perspective view of an optical ruler unit, in accordance with some embodiments of the present disclosure.

FIG. 7A, FIG. 7B, FIG. 7C, FIG. 7D, FIG. 7E, FIG. 7F, FIG. 7G, and FIG. 7H illustrate one or more operations of a method for performing a robotic action, in accordance with some embodiments of the present disclosure.

Common reference numerals are used throughout the drawings and the detailed description to indicate the same or similar elements. The present disclosure will be more apparent from the following detailed description taken in conjunction with the accompanying drawings.

### DETAILED DESCRIPTION

The following disclosure provides different embodiments, or examples, for implementing different features of the provided subject matter. Specific examples of components and embodiments are recited herein. These are, of course, merely examples and are not intended to be limiting. In the present disclosure, reference to the formation of a first feature over or on a second feature in the description that follows may include embodiments in which the first and second features are formed in direct contact, and may also include embodiments in which additional features may be formed between the first and second features, such that the first and second features may not be in direct contact. The present disclosure may repeat reference numerals and/or letters in the various examples. This repetition is for simplicity and clarity and does not in itself dictate a relationship between the various embodiments and/or configurations discussed.

Embodiments of the present disclosure are discussed in detail as follows. It should be appreciated, however, that the present disclosure provides many applicable concepts that can be embodied in a wide variety of specific contexts. The specific embodiments discussed are merely illustrative and do not limit the scope of the disclosure.

Embodiments of the present disclosure discuss an electronic device including a robotic arm with sensors mounted thereon. The proposed electronic device can simplify complex actions into modular operations or functions based on different scenarios. The proposed electronic device provide a first sensing element for coarse distance detection and a second sensing element of the robotic arm for accurate distance detection, and thus the robotic arm can provide the modular function (such as grabbing objects) based on the data detected by the two sensing elements. In some cases, the second sensing element can be mounted on a palm or a fingertip of the robotic arm. Furthermore, the robotic arm can be retractable with optical ruler, such that the robotic arm can elongate precisely to grab the object.

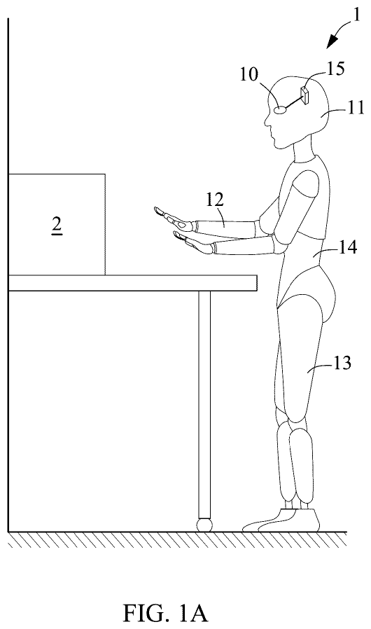

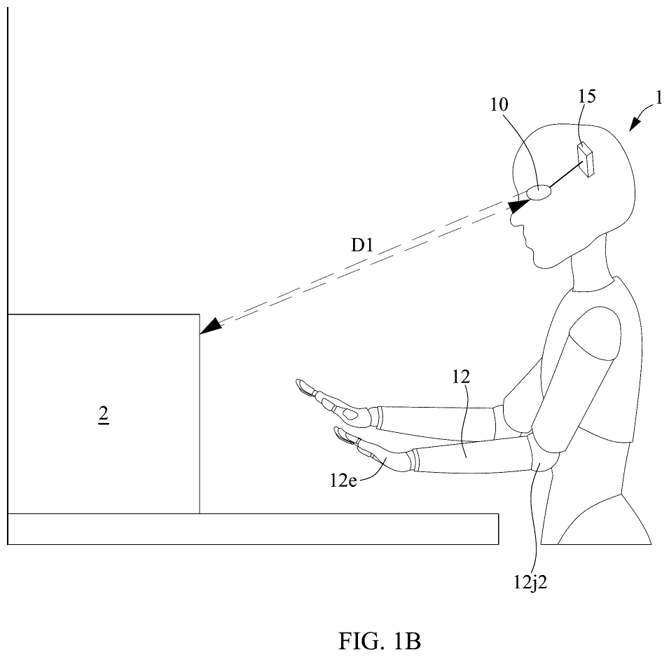

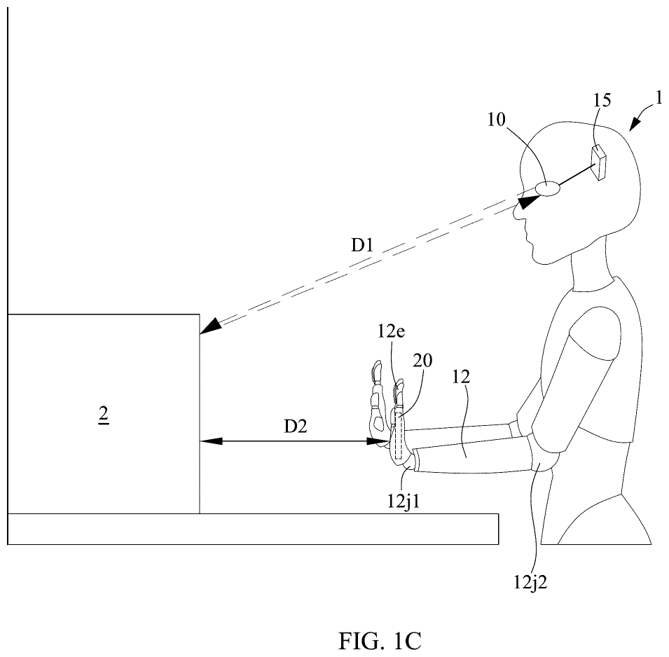

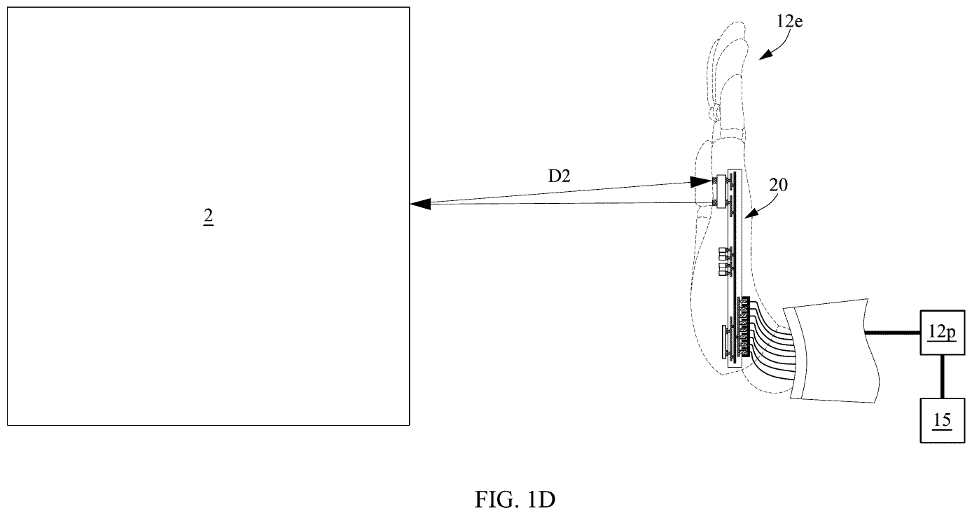

FIG. 1A, FIG. 1B, and FIG. 1C illustrate one or more operations of a method for performing a robotic action, in accordance with some embodiments of the present disclosure. FIG. 1D is an enlarged perspective view of FIG. 1C, in accordance with different embodiments of the present disclosure.

Referring to FIG. 1A, an electronic device 1 (for example, a robot 1) may be in front of an object 2 to be grabbed by the electronic device 1, where the object 2 may be placed on a table, a stage, or a platform. The robot 1 may include one or more robotic bodies, for example a head portion 11, one or more robotic arms 12 (or hand portions), one or more robotic legs 13 (or leg portions), and a body portion 14. The head portion 11, the robotic arms 12, and the robotic legs 13 may be connected to the body portion 14. The robotic arms 12 and the robotic legs 13 may include one or more arm portions and one or more joints connecting the adjacent arm portions.

The robot 1 may include a first sensing element 10 and a processor 15. The first sensing element 10 may be disposed at the head portion 11. The first sensing element 10 may be configured to simulate the eyes. The processor 15 may be disposed at the head portion 11. In other embodiments, the processor 15 may be disposed at other portions of the robot 1. The processor 15 may be a central control unit of the robot 1. That is, the processor 15 may be the main control unit as a brain of the robot 1. In some embodiments, the processor 15 may be configured to drive the robotic bodies (i.e., the head portion 11, the robotic arms 12, or the robotic legs 13) in response to the data or signals detected by the first sensing element 10. The processor 15 may be configured to utilize AI model for analyzing, identifying, computing, or other functions. In other embodiments, the robot 1 may include other sensors (not shown) mounted on the robotic arms 12, robotic legs 13, or other positions, and the processor 15 may be configured to drive the robot 1 to make specific actions in response to the data detected by the sensors of the robot 1.

Referring to FIG. 1B, the robot 1 may move closer to the object 2 and the first sensing element 10 may detect a distance D1 between the robot 1 (in particular, the head portion 11) and the object 2 to be grabbed on a first scale. In some embodiments, the first sensing element 10 may include an infrared sensor or an ultrasonic sensor. The signals/data detected by the first sensing element 10 may be transmitted to the processor 15 for subsequent processes and then the processor 15 may be configured to drive the robot 1 to make corresponding actions accordingly. For example, the robot 1 (the body portion 14 or all robot bodies) may be configured to move toward the object 2 in response to the distance D1 detected by the first sensing element 10.

Referring to FIG. 1C and FIG. 1D, the robot 1 may include a second sensing element 20 disposed on the robotic arm 12. In some embodiments, the second sensing element 20 may be disposed on an end 12e of the robotic arm 12. For example, the second sensing element 20 may be disposed on a palm or hand portion (i.e., the end 12e) of the robotic arm 12. The second sensing element 20 may be configured to detect a distance D2 between the robot 1 (in particular, the palm portion of the robotic arm 12) and the object 2 on a second scale, wherein the precision of the second scale of the second sensing element 20 may be different from that of the first scale of the first sensing element 10. For example, the precision of the second scale of the second sensing element 20 is greater than that of the first scale of the first sensing element 10. In other words, the resolution of the second sensing element 20 may be more precise than that of the first sensing element 10. In some embodiments, under the computation of the processor 15, the horizontal distance (derived from the distance D1) between the object 2 and the robot 1 detected by the first sensing element 10 may be about 60 cm, while the distance D2 (for example, the horizontal distance) detected by the second sensing element 20 may be about 63.25 cm. In some embodiments, the second sensing element 20 may include a vertical-cavity surface-emitting laser (VCSEL) sensor or a time of flight (ToF) sensor.

The signals/data detected by the second sensing element 20 may be transmitted to the processor 15 for subsequent processes and then the processor 15 may be configured to drive the robot 1 to make corresponding actions accordingly. In some embodiments, the signals/data detected by the second sensing element 20 may be transmitted to a processor 12p that is embedded in the robotic arm 12 and electrically connected to the processor 15 for subsequent processes. The processor 12p may be configured to drive the robotic arm 12 to make a predetermined modular action. For example, the predetermined modular action may be a grab operation. That is, a portion of the robot 1 (such as, the robotic arm 12) may be configured to move toward the object 2 for grabbing the object 2, in response to the distance D2 detected by the second sensing element 20. In some embodiments, other robot bodies may be fixed or stable during the robotic arm 12 moves. The robotic arm 12 may be configured to be straightened to grab the object 2.

In some embodiments, the modular actions performed by the robot 1 may include, but not limited to, grabbing objects, picking up objects, moving objects, pressing objects, holding objects with one or more fingers and/or thumb, opening bottles, packing or unpacking, and the like.

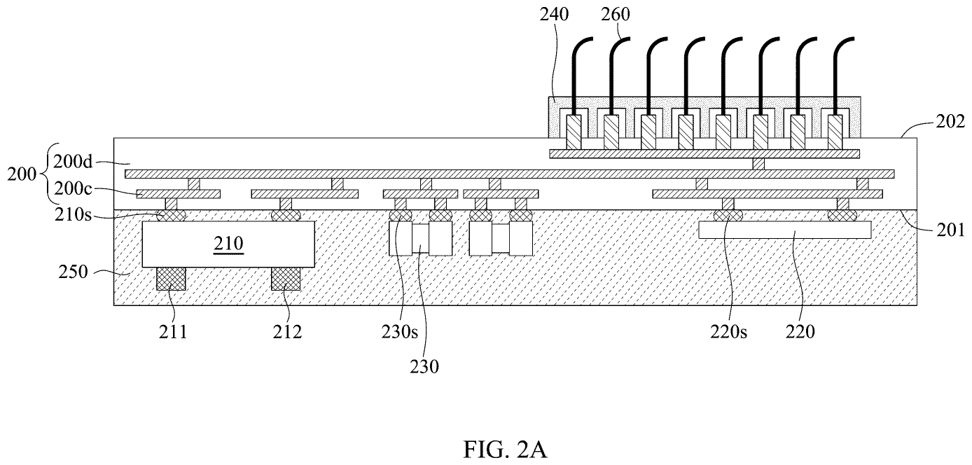

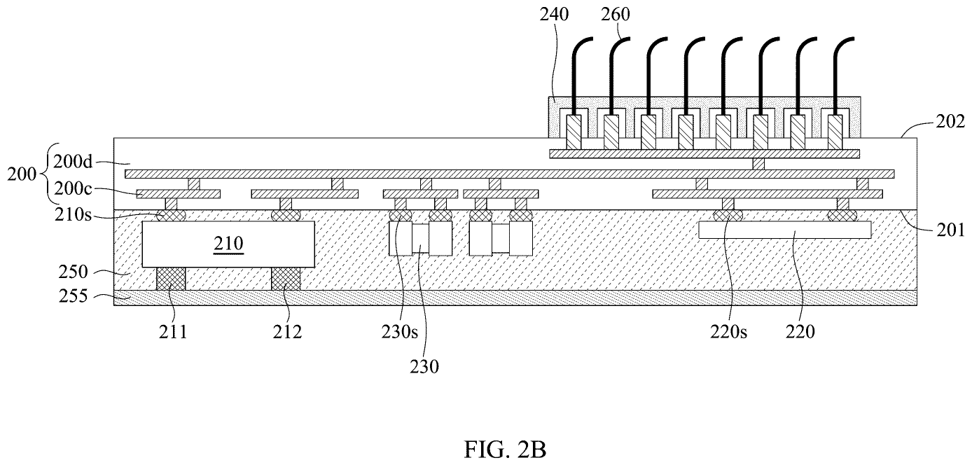

FIG. 2A is a cross-section of a sensing element 20a, in accordance with some embodiments of the present disclosure. The sensing element 20a may be a kind of electronic devices. The sensing element 20a may be the same as the second sensing element 20 shown in FIG. 1A to FIG. 1D. The sensing element 20a may include a substrate 200, a detector 210, one or more electronic components 220, one or more passive devices 230, a connector 240, an encapsulant 250, and electrical connections 260.

Referring to FIG. 2, the substrate 200 may have a bottom surface 201 and a top surface 202 opposite to the bottom surface 201. In some embodiments, the substrate 200 may be a multilayered substrate. The substrate 200 may include, for example, a printed circuit board, such as a paper-based copper foil laminate, a composite copper foil laminate, or a polymer-impregnated glass-fiber-based copper foil laminate. In some arrangements, the substrate 200 includes a ceramic material, a metal plate, an organic substrate, or a leadframe. The substrate 200 may include a flexible substrate, such as flexure circuit board (FPC).

The substrate 200 may include one or more dielectric layers 200d and interconnection structures 200c formed in the dielectric layers 110d. The dielectric layers 200d may be a multilayered structure. The interconnection structures 200c may include pads, conductive traces, and conductive vias connecting the conductive traces/pads. The pads of the interconnection structures 200c may be exposed from the dielectric layer 200d to connect to elements mounted on the substrate 200. The pads can protrude from the bottom surface 201 or the top surface 202. In another embodiment, the pads may be embedded in the dielectric layer 200d and exposed by the dielectric layer 200d. That is, a surface of the pads may be coplanar with the bottom surface 201 or the top surface 202. In some embodiments, the interconnection structures 200c may include a conductive material such as a metal or metal alloy. Examples of the conductive material include gold (Au), silver (Ag), aluminum (Al), copper (Cu), or an alloy thereof. The substrate 200 may be a supporting element of the sensing element 20a.

In some embodiments, the detector 210 may be disposed on the bottom surface 201 of the substrate 200. The detector 210 may be electrically connected to the substrate 200 through one or more solder elements 210s. In some embodiments, the detector 210 may be a distance sensor. The detector 210 may include an emitter 211 and a receiver 212. The emitter 211 and the receiver 212 may be disposed on the bottom surface 201 of the substrate 200. The emitter 211 and the receiver 212 face away from the bottom surface 201. The receiver 212 may be disposed adjacent to the emitter 211. The detector 210 may be configured to measure the distance between itself and an object. In some embodiments, the detector 210 may be configured to emit a signal (such as, optical signals, infrared beams, ultrasonic waves, lasers) by the emitter 211, and then receive the signal reflected by objects (such as the object 2) by the receiver 212. The detector 210 may be configured to calculate the distance based on the time difference between emitting signal and receiving the reflected signals.

In some embodiments, the electronic component 220 may be disposed on the bottom surface 201 of the substrate 200. The electronic component 220 may be electrically connected to the substrate 200 through one or more solder elements 220s. The electronic component 220 and the detector 210 may be disposed on opposite sides of the substrate 200. The electronic component 220 may be electrically connected to the detector 210 through the substrate 200. The electronic component 220 may include active devices, such as filters, power IC, microcontroller, or the like.

In some embodiments, the passive devices 230 may be disposed on the bottom surface 201 of the substrate 200. The passive devices 230 may be electrically connected to the substrate 200 through one or more solder elements 230s. The passive devices 230 may be disposed adjacent to the detector 210. The passive devices 230 may be electrically connected to the detector 210 through the substrate 200. The passive devices 230 may include resistors, capacitors, inductors, or a combination thereof.

In some embodiments, the encapsulant 250 may be disposed on the bottom surface 201 of the substrate 200. The encapsulant 250 may cover or encapsulate the detector 210, the electronic components 220, and the passive devices 230 to form a package (i.e., the sensing element 20a) on or embedded in the robot hand (such as the robotic arm 12 in FIG. 1A to FIG. 1C).

The encapsulant 250 may include a material that is transparent to electromagnetic waves or lights, ensuring that the detector 210 functions effectively. The encapsulant 250 may include an epoxy resin having fillers dispersed therein, a molding compound (e.g., an epoxy molding compound or other molding compound), polyimide (PI), a phenolic compound or material, a polymer material with silicone dispersed therein, or a combination thereof. For example, the encapsulant 250 may include silicone or thermoplastic.

In some embodiments, the connector 240 may be disposed on the top surface 202 of the substrate 200. The connector 240 and the detector 210 may be disposed on opposite surfaces of the substrate 200. The connector 240 may be electrically connected to the substrate 200. The connector 240 may be electrically connected to the detector 210 through the substrate 200. The connector 240 may be electrically connected to the emitter 211 and the receiver 212 through the substrate 200.

In some embodiments, the electrical connections 260 may connected to the substrate 200 through the connector 240. The sensing element 20a may connect to other elements (for example, the processor 15) through the electrical connections 260. In some embodiments, the electrical connections 260 may be conductive wires or cables.

FIG. 2B is a cross-section of a sensing element 20b, in accordance with some embodiments of the present disclosure. The sensing element 20b is similar to the sensing element 20a in FIG. 2A, and the differences therebetween are as follows.

Referring to FIG. 2B, the sensing element 20b further includes a protection layer 255 disposed on the encapsulant 250. The protection layer 255 may be disposed on the emitter 211 and the receiver 212. The protection layer 255 may be a hard board disposed on a bottom surface of the encapsulant 250. The protection layer 255 may be wear-resistant to protect the detector 210, and transparent to electromagnetic waves or lights, ensuring that the detector 210 functions effectively. The protection layer 255 may include transparent polymer materials. For example, the protection layer 255 may include acrylic board, polycarbonate board, or the like. The encapsulant 250 may be disposed between the protection layer 255 and the substrate 200. In some embodiments, the bottom surface of the encapsulant 250 may be aligned with the emitter 211 and the receiver 212.

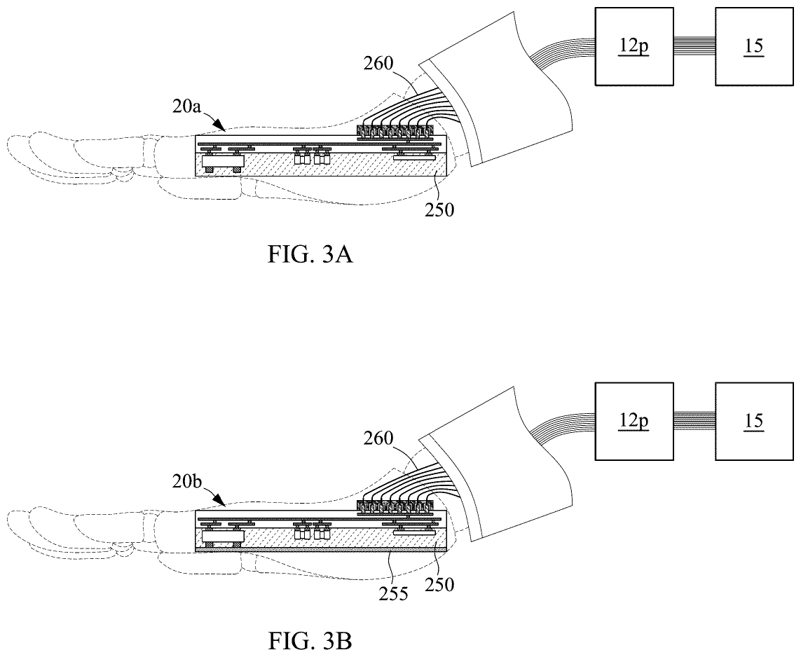

FIG. 3A is a schematic diagram of an electronic device 20a, in accordance with some embodiments of the present disclosure. In FIG. 3A, the electronic device (sensing element) 20a may be embedded in a portion of a robotic arm. In some embodiments, the sensing element 20a may be embedded in the palm portion of the robotic arm. In some embodiments, the encapsulant 250 may be the outmost surface of the robotic arm.

In some embodiments, the electrical connections 260 may electrically connect the sensing element 20a to the processor 12p that may be integrated in the robotic arm. This connection facilitates the transmission of signals and data that are detected by the detector 210. Once the data/signals are received by the processor 12p, it can be processed to enable the robotic arm to execute a variety of predetermined modular actions. The processor 15 of the robot 1 may be electrically connected to the processor 12p of the robotic arm for subsequent processes. These modular actions are pre-programmed sequences that the robotic arm can perform, allowing it to carry out tasks with precision and efficiency. The processor 12p may be configured to process the data/signals from the sensing element 20a to make adjustments to the robotic arm's movements, ensuring that it operates smoothly and effectively. Furthermore, the robot 1 may include a main processor 15, which may be electrically connected to the processor 12p of the robotic arm. This connection allows for a seamless flow of information between the two processors, enabling coordinated actions and enhancing the overall functionality of the robot.

In another embodiment, the processor 12p may be optionally omitted. That is, the electrical connections 260 may electrically connect the sensing element 20a to the processor 15. Once the data/signals are received by the processor 15, the processor 15 may be configured to enable the robot to execute a variety of actions in response to the data/signals.

FIG. 3B is a schematic diagram of an electronic device 20b, in accordance with some embodiments of the present disclosure. The electronic device 20b is similar to the electronic device 20a in FIG. 3A, and the differences therebetween are that the electronic device 20b includes a protection layer 255. In some embodiments, the protection layer 255 may be the outmost surface of the robotic arm.

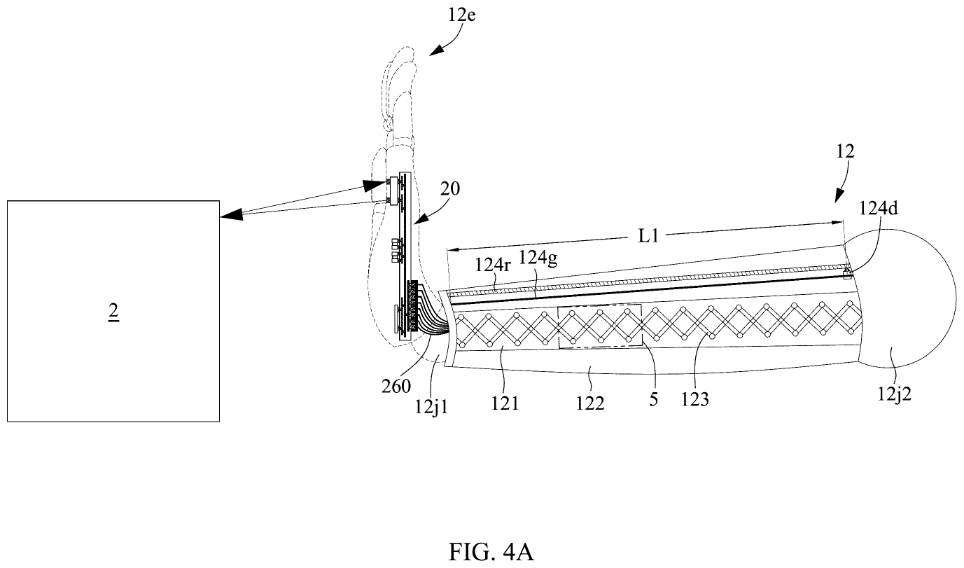

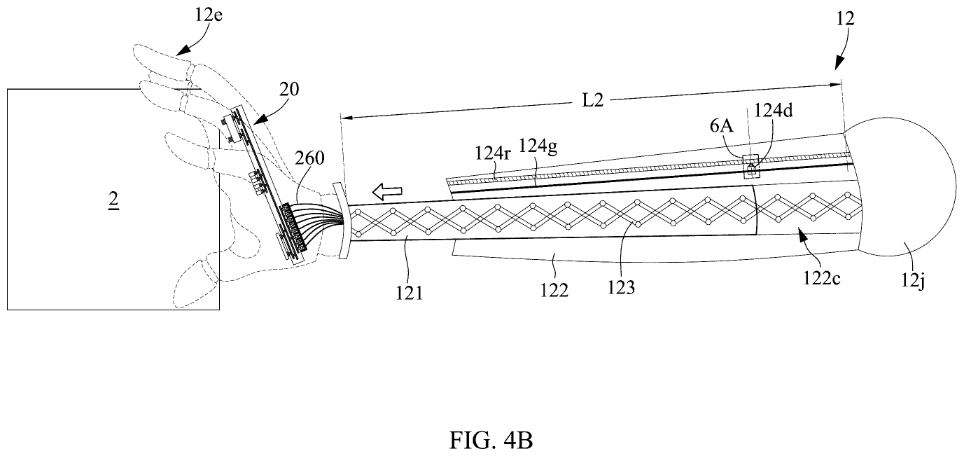

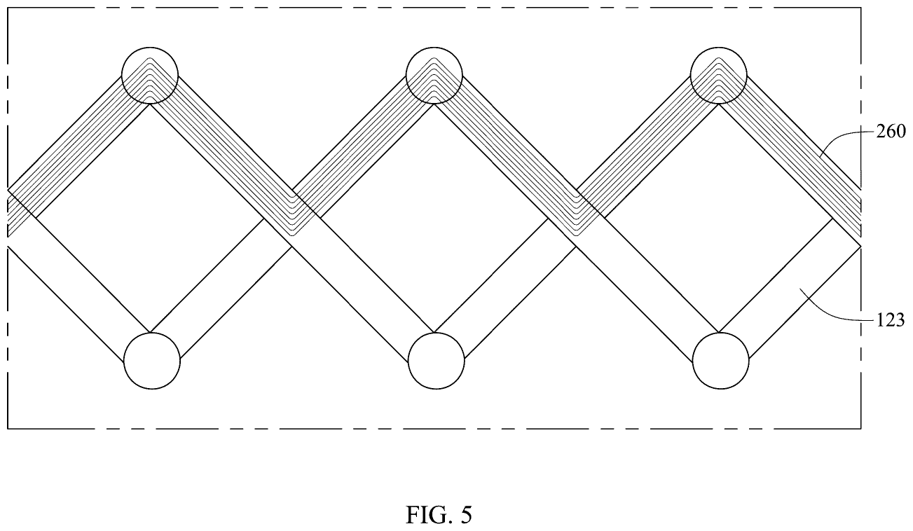

FIG. 4A is a schematic diagram of a retractable robotic arm 12, in accordance with some embodiments of the present disclosure. FIG. 4B is a schematic diagram of a retractable robotic arm 12, in accordance with some embodiments of the present disclosure. In some embodiments, the robotic arm 12 may include a telescoping structure. FIG. 4A shows the robotic arm 12 at an initial (shortened) state and FIG. 4B shows the robotic arm 12 at an extension (lengthened) state.

Referring to FIGS. 4A and 4B, the robotic arm 12 may include a palm portion 12e, joints 12j1 and 12j2, an inner part 121, an outer part 122, a retractable element 123, an optical ruler unit 124, and a sensing element 20. In some embodiments, the sensing element 20 may be a type of either the sensing element 20a or 20b. In some embodiments, the robotic arm 12 may be retractable to extend and reach an object 2 to be grabbed.

The palm portion 12e may be an end of the robotic arm 12. The robotic arm 12 may have one or more fingers and/or thumb connected to the palm portion 12e. The sensing element 20 may be disposed at the palm portion 12e. In other embodiments, the sensing element 20 may be disposed at the fingers and/or thumb of the robotic arm 12.

The palm portion 12e may be connected to the inner portion 121 through a joint 12j1. The joint 12j1 may be configured to rotate the palm portion 12e. The palm portion 12e may be configured to substantially face the object 2 by rotating the joint 12j1, enabling the sensing element 20 to face the object 2.

The inner part 121 and the outer part 122 may define an arm portion of the robotic arm 12 that is telescoping or retractable. The inner part 121 may be different or independent from the outer part 122. The inner part 121 may be partially embedded in the outer part 122. In some embodiments, the inner part 121 is adjustable relative to the outer part 122. The outer part 122 may have a cavity 122c (see FIG. 4B) accommodating the inner part 121.

The outer part 122 may be connected to the joint 12j2, and the joint 12j2 may be configured to rotate the arm portion of the robotic arm 12 to align with the object 2. The arm portion (including the inner part 121 and the outer part 122) may be between the joints 12j1 and 12j2. By controlling the joints 12j1 and 12j2, the robotic arm 12 can be configured to be about an elevation substantially identical to that of the object 2 and the sensing element 20 can face the object 2, to facilitate the detection of the distance between the robotic arm 12 and the object 2.

The retractable element 123 may be located within the cavity 122c of the outer part 122 and connect the inner part 121 to the outer part 122. The retractable element 123 may be configured to change a length of the arm portion of the robotic arm 12. In some embodiments, the retractable element 123 may be configured to elongate and/or rotate the arm portion of the robotic arm 12. The retractable element 123 may be configured to change a first length L1 (see FIG. 4A) of the arm portion to a second length L2 (see FIG. 4B), such that the robotic arm 12 can capture the object 2. In some embodiments, the retractable element 123 may be a folded structure that includes multiple arms and joints connecting the arms. When the retractable element 123 elongates, the angle between two adjacent arms may increase (such as greater than 90 degrees). On the contrary, when the retractable element 123 shortens, the angle between two adjacent arms may decrease (such as less than 90 degrees).

With the retractable element 123, the inner part 121 of the telescoping arm portion may extend out of or slide out from the outer part 122 of the telescoping arm portion when lengthened, and the inner part 121 may retract or enclosed within the outer part 122 when shortened. The telescoping robotic arm may be configured to elongate or retract in response to data/signals detected by the sensing element 20. In some embodiments, the inner part 121 may be configured to move in response to data detected by the second sensing element 20. In some embodiments, the electrical connections 260 may be embedded in the joint 12j1, the inner part 121, and the joint 12j2. The electrical connections 260 may electrically connect the sensing element 20 to the processor 15. The processor 15 may be configured to drive the inner part 121 to hold or grab the object 2 without moving the outer part 122. In some embodiments, the inner part 121 is configured to linearly move toward the object 2 without moving the outer part 122 when the distance D2 is less than a threshold (i.e., the maximum length of robotic arm 12 when lengthened). In some embodiments, a distance between the object 2 and the joint 12j may remain the same during grabbing or capturing the object 2.

FIG. 5 is an enlarged perspective view of a region “5” in FIG. 4A, in accordance with different embodiments of the present disclosure. The electircal connections 260 may be embedded in the arms and joints of the retractable element 123. The electrical connections 260 may be connected to the sensing element 20 and the processor 15.

Referring back to FIGS. 4A and 4B, the optical ruler unit 124 may be mounted on the outer part 122 of the robotic arm 12. The optical ruler unit 124 may be embedded in the outer part 122. The optical ruler unit 124 may be connected to the inner part 121, and configured to determine a moving amount of the inner part 121 of the robotic arm 12.

The optical ruler unit 124 may include a ruler 124r and a detector 124d. In some embodiments, the ruler 124r may be linear. The ruler 124r may extend between the joint 12j1 and 12j2. In some embodiments, the detector 124d may be an optical detector. The detector 124d may be attached to or mounted on a guide 124g, such that the detector 124d may slide along the guide 124g. In some embodiments, the detector 124d may be connected to the inner part 121 and movable along with the movement of the inner part 121. The detector 124d may be connected to an end of the inner part 121 and configured to slide along the guide 124g depending on the movement of the inner part 121. Integrated the optical ruler unit 124, the retractable robotic arm 12 can elongate precisely to grab the object 2.

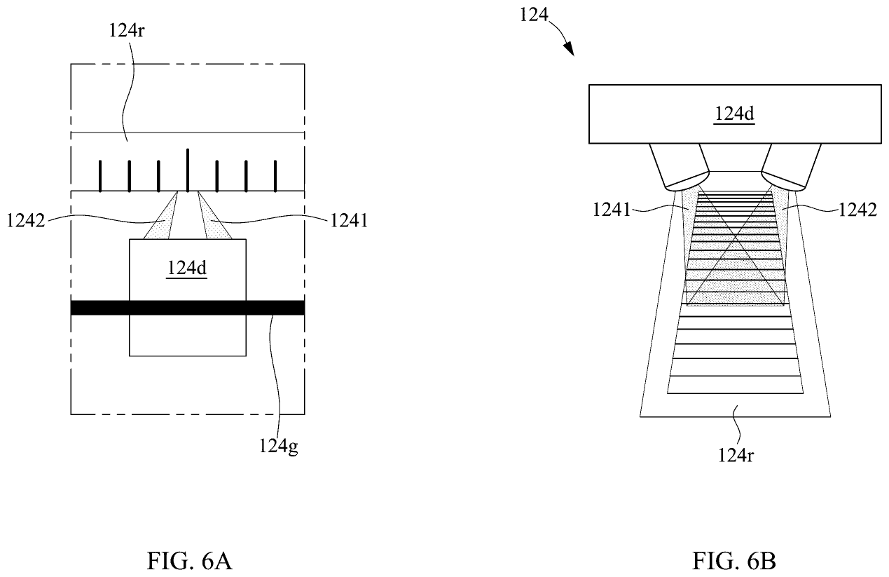

FIG. 6A is an enlarged perspective view of a region “6A” in FIG. 4B, in accordance with some embodiments of the present disclosure. Referring to FIG. 6A, the optical detector 124d may be mounted on the guide 124g. The optical detector 124d may be configured to emit optical signals (lights) 1241 to the ruler 124r and then reflected optical signals 1242 reflected by the ruler 124r back to the optical detector 124d, such that the optical detector 124d may be configured to identify a scale mark of the ruler 124r during the inner part 121 moving.

FIG. 6B is a perspective view of an optical ruler unit 124, in accordance with some embodiments of the present disclosure. Referring to FIG. 6B, the optical ruler unit 124 may include the optical detector 124d and the ruler 124r. The optical detector 124d can be configured to emit optical signals (lights) 1241 towards the ruler 124r. These signals can then be reflected back as optical signals 1242 by the ruler 124r to the optical detector 124d. This configuration allows the optical detector 124d to identify the scale mark on the ruler 124r while the inner part 121 is in motion.

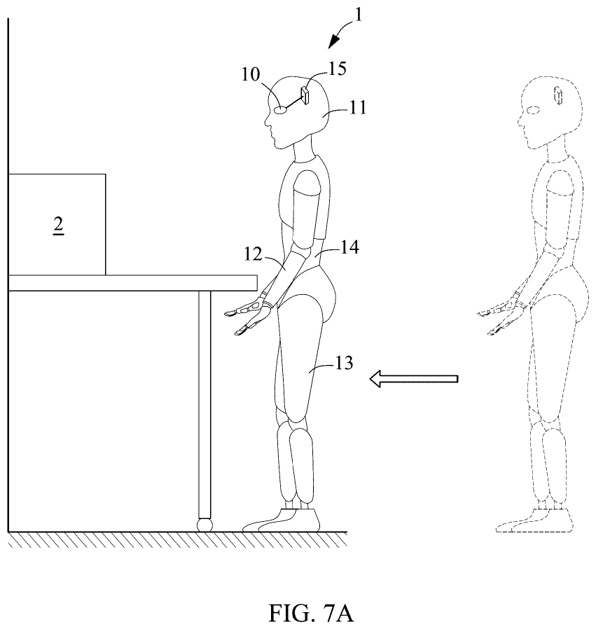

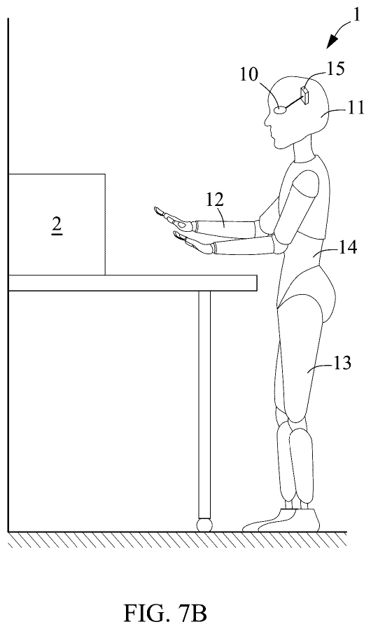

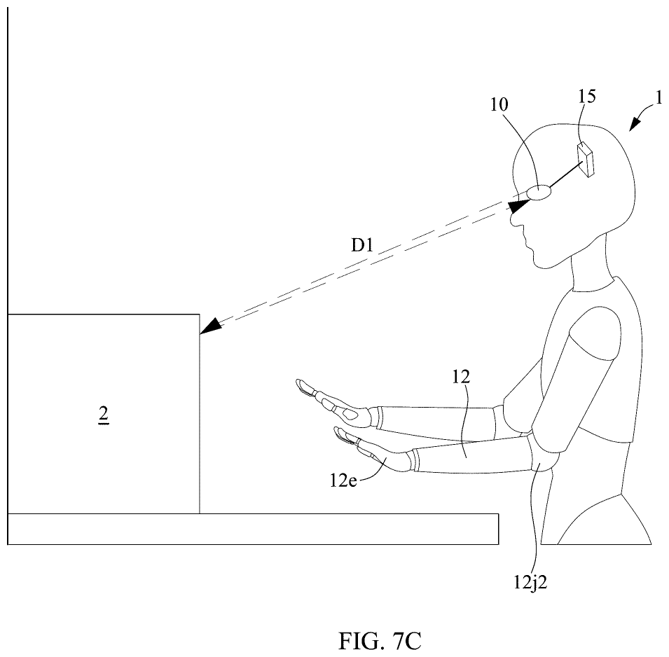

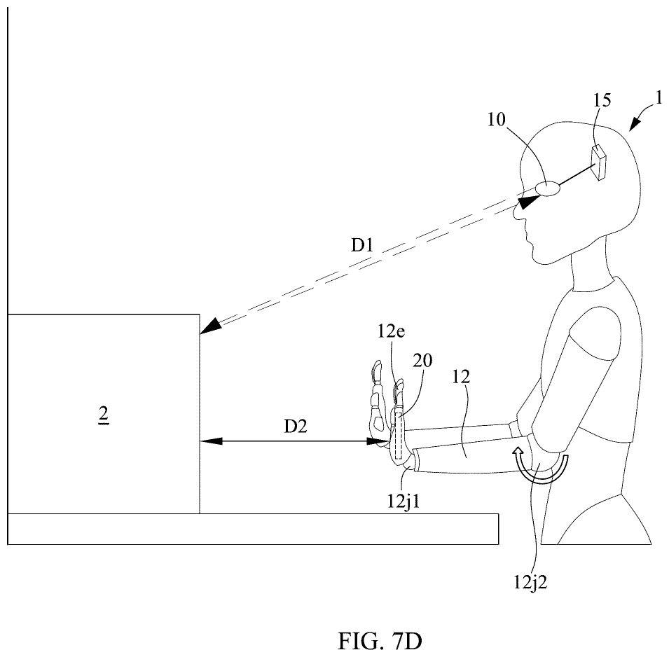

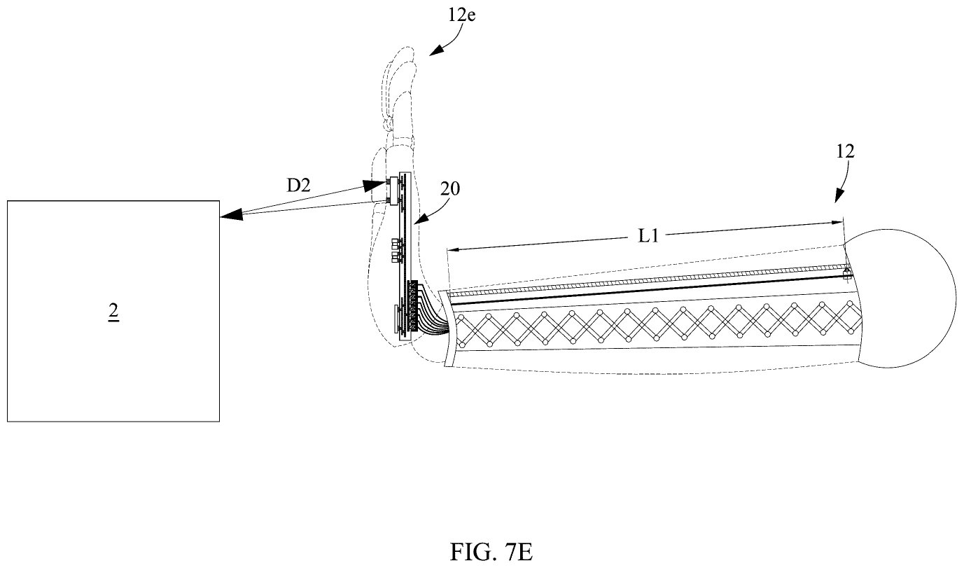

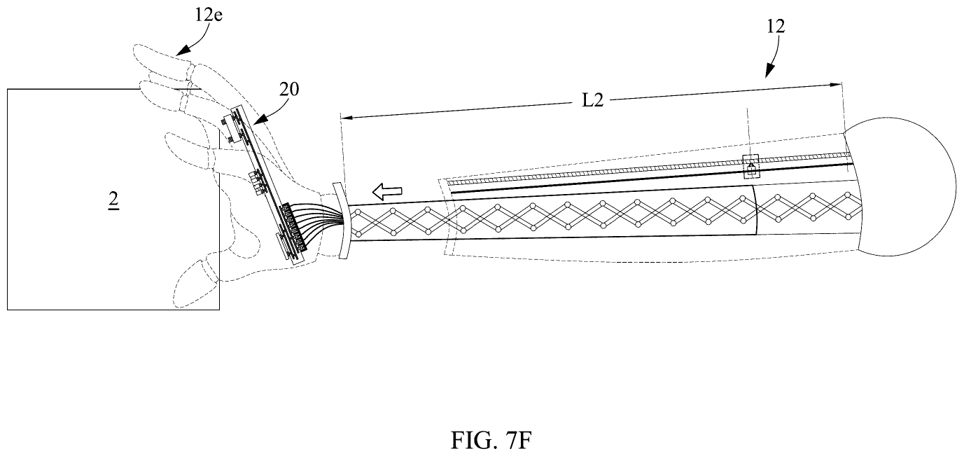

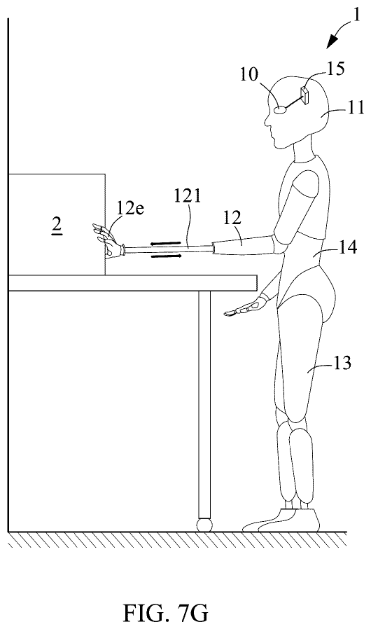

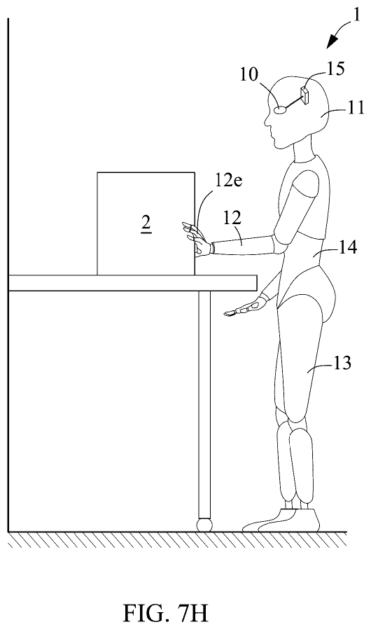

FIG. 7A, FIG. 7B, FIG. 7C, FIG. 7D, FIG. 7E, FIG. 7F, FIG. 7G, and FIG. 7H illustrate one or more operations of a method for performing a robotic action, in accordance with some embodiments of the present disclosure. The robot 1 in FIGS. 7A-7H is similar to the robot 1 in FIGS. 1A-1D.

Referring to FIG. 7A, an electronic device 1 (for example, a robot 1) may be provided in front of an object 2 to be grabbed by the electronic device 1, where the object 2 may be placed on a table, a stage, or a platform. The robot 1 may include one or more robotic bodies, for example a head portion 11, one or more robotic arms 12 (or hand portions), one or more robotic legs 13 (or leg portions), and a body portion 14.

The robot 1 may include a first sensing element 10 and a processor 15. The first sensing element 10 may be located at the head portion 11. The processor 15 may be located at the head portion 11. In other embodiments, the processor 15 may be disposed at other portions of the robot 1. The processor 15 may be a central control unit of the robot 1. In some embodiments, the processor 15 may be configured to drive the robotic bodies (i.e., the head portion 11, the robotic arms 12, the robotic legs 13, or the body portion 14) in response to the data or signals detected by the first sensing element 10. The processor 15 may be configured to drive the robot 1 to make specific actions in response to the data detected by the sensors of the robot 1.

In some embodiments, the first sensing element 10 may be configured to detect a distance between the object 2 to be grabbed and the robot body (i.e., the robot 1) on a first scale. The robot 1 may be configured to move toward the object 2. The robot 1 may be configured to move closer to the object 2 in response to the distance between the object 2 and the robot detected by the first sensing element 10. In some embodiments, the first sensing element 10 may include an infrared sensor or an ultrasonic sensor. The signals/data detected by the first sensing element 10 may be transmitted to the processor 15 for subsequent processes and then the processor 15 may be configured to drive the robot 1 to make corresponding actions accordingly. For example, the robot 1 (all robot bodies) may be configured to move toward the object 2 in response to the distance detected by the first sensing element 10.

The processor 15 may be electrically connected to the robotic bodies (such as, the head portion 11, the robotic arms 12, the robotic legs 13, or the body portion 14) and the first sensing element 10. The first sensing element 10 may be configured to detect the distance between the object 2 and the robot 1 continuously. The processor 15 may be configured to drive the robotic arm 12 to move toward the object 2 in response to data detected by the first sensing element 10 until the distance to the object 2 less than a predetermined threshold. That is, the robot 1 may stop moving until the distance to the object 2 less than the predetermined threshold. In some embodiments, the predetermined threshold may be the initial length of the robotic arm 12 (under retracted state), or the extended length of the robotic arm 12.

Referring to FIG. 7B, the robot 1 may be configured to close to the object 2 and determine whether a grabbing operation should be conducted. The robot 1 may be configured to make specific actions in response to the data detected by the first sensing element 10.

Referring to FIG. 7C, the first sensing element 10 may be configured to detect a distance D1 between the object 2 to be grabbed and the robot body (i.e., the robot 1) on a first scale. The processor 15 may be configured to drive the robotic arm 12 to move toward the object 2 in response to data detected by the first sensing element 10. In some embodiments, the distance D1 between the object 2 and the robot 1 detected by the first sensing element 10 may be about centimeter level. For example, the distance D1 may be about 30, 40, 50, or 60 cm.

Referring to FIG. 7D, the processor 15 may be configured to drive the robotic arm 12. After the robot 1 moves close enough to the object 2, the robotic arm 12 may be configured to perform specific actions. For example, the robotic arm 12 (including the inner part 121 and the outer part 122) may be configured to move in response to data detected by the first sensing element 10. In some embodiments, the joint 12j2 may be configured to rotate the robotic arm 12 to align with the object 2 to be grabbed. For example, the robotic arm 12 may be configured to be parallel to the table that support the object 2. In some embodiments, the joint 12j1 may be configured to rotate the palm portion 12e, such that the second sensing element 20 embedded in the palm portion 12e may face the object 2 to be grabbed. Accordingly, the subsequent measurement of the distance between the palm portion 12e and the object 2 can be accurate.

Referring to FIG. 7E, the second sensing element 20 may be configured to detect a distance D2 between the object 2 to be grabbed and the robot body (i.e., the robotic arm 12 of the robot 1) on a second scale, wherein a precision of the second scale of the second sensing element 20 may be different from that of the first scale of the first sensing element 10. For example, the precision of the second scale of the second sensing element 20 is greater than that of the first scale of the first sensing element 10. In other words, the resolution of the second sensing element 20 may be more precise than that of the first sensing element 10. The first scale of the first sensing element 10 may be around centimeter level, and the second scale of the second sensing element 20 may be around millimeter level. In some embodiments, under the computation of the processor 15, the horizontal distance (derived from the distance D1) between the object 2 and the robot 1 detected by the first sensing element 10 may be about 30 cm, while the distance D2 (for example, the horizontal distance) detected by the second sensing element 20 may be about 32.53 cm. In some embodiments, the second sensing element 20 may include a vertical-cavity surface-emitting laser (VCSEL) sensor or a time of flight (ToF) sensor. At this stage, the retractable robotic arm 12 may have a length L1.

Referring to FIG. 7F, the retractable robotic arm 12 may be configured to elongate to reach and grab the object 2 in response to the data/signals detected by the second sensing element 20. The retractable robotic arm 12 may be controlled by the processor 15 or 12p. The retractable robotic arm 12 may be configured to change from the first length L1 to a second length L2, which is longer than the first length L1. The processor 15 may be configured to drive the inner part 121 to hold the object 2 without moving the outer part 122. The inner part 121 may be configured to move in response to data detected by the second sensing element 20. For example, when the distance D2 is 32.53 cm, the retractable robotic arm 12 may elongate 32.53 cm to reach and grab the object 2. That is, the difference between the first length L1 and the second length L2 is 32.35 cm. In some embodiments, the moving amount of the inner part 121 can be monitored accurately by the optical ruler unit 124, such that the elongation of the retractable robotic arm 12 can be performed accurately as well.

Referring to FIG. 7G, the retractable robotic arm 12 may be configured to elongate to reach and grab the object 2, and then retract back to the initial length. The robotic arm 12 may be configured to linearly move the inner part 121 to reach and grab the object 2, during which a distance between the object 2 and the joint 12j remains unchanged. The robotic arm 12 may be configured to lengthen by moving the inner part 121 to reach and grab the object 2, and then shorten by moving the inner 121 back to the cavity of the outer part 122.

Referring to FIG. 7H, the robotic arm 12 may be configured to hold the object 2. Accordingly, the grabbing operation can be completed. In some embodiments, the robot 1 can hold the object 2 and move it to another place for subsequent operations.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a first sensing element configured to detect a distance to an object to be grabbed on a first scale; and
a second sensing element configured to detect the distance to the object on a second scale, wherein a precision of the second scale is different than that of the first scale.

2. The electronic device of claim 1, further comprising a first part configured to move toward the object in response to the distance detected by the first sensing element.

3. The electronic device of claim 2, further comprising a second part connected to the first part, wherein the second part is configured to move toward the object in response to the distance detected by the second sensing element.

4. The electronic device of claim 3, wherein the second part includes a first portion and a second portion at least partially embedded in the first portion, wherein a location of the second portion is adjustable relative to the first portion.

5. The electronic device of claim 4, wherein the second portion are configured to move in response to data detected by the second sensing element.

6. The electronic device of claim 4, further comprising an electrical connection embedded in the second portion and connected to the second sensing element.

7. The electronic device of claim 1, wherein the first sensing element includes an infrared sensor or an ultrasonic sensor.

8. The electronic device of claim 1, wherein the second sensing element includes a vertical-cavity surface-emitting laser (VCSEL) sensor or a time of flight (ToF) sensor.

9. An electronic device, comprising:
a robot body; and
a first sensing element configured to detect a distance between an object to be grabbed and the robot body,
wherein a first part of the robot body is configured to linearly move toward the object without moving a second part of the robot body when the distance is less than a threshold, wherein the first part is different from the second part.

10. The electronic device of claim 9, wherein the first part of the robot body includes a portion facing the object, and the first sensing element is disposed on the portion.

11. The electronic device of claim 10, wherein the robot body includes a first joint connected to the portion, wherein the first joint is configured to rotate the portion of the robot body to face the object.

12. The electronic device of claim 11, further comprising:
a ruler mounted on the second part of the robot body; and
an optical detector connected to the first part of the robot body and movable in accordance with a movement of the first part, and wherein the optical detector is configured to identify a scale mark of the ruler during the first part moves.

13. The electronic device of claim 9, further comprising a substrate supporting the first sensing element.

14. The electronic device of claim 13, further comprising an encapsulant encapsulating the substrate and the first sensing element to form a package on or embedded in the second part.

15. The electronic device of claim 14, wherein the encapsulant includes a material that is transparent to electromagnetic waves or lights.

16. An electronic device, comprising:
a robotic part including a retractable element, wherein the retractable element is configured to elongate and/or rotate the robotic part; and
a first sensing element configured to detect a first distance between the robotic part and an object to be grabbed,
wherein the robotic part is configured to change a length of the robotic part to capture the object based on data detected by the first sensing element associated with the first distance.

17. The electronic device of claim 16, wherein the first sensing element includes:
a substrate having a first surface and a second surface opposite to the first surface;
an emitter disposed on the first surface;
a receiver disposed adjacent to the emitter on the first surface; and
an encapsulant encapsulating the emitter, the receiver, and the substrate.

18. The electronic device of claim 17, wherein the first sensing element further includes a connector disposed on the second surface of the substrate, the connector electrically connected to the emitter and the receiver through the substrate.

19. The electronic device of claim 17, wherein the first sensing element further includes a protection layer disposed on the emitter and the receiver, wherein the encapsulant is disposed between the protection layer and the substrate.

20. The electronic device of claim 16, wherein the robotic part includes a joint configured to rotate the robotic part, and wherein a distance between the object and the joint remains the same during capturing the object.
